(19) United States
(12) Patent Application Publication
(10) Pub. No.: US 2005/0083256 A1
(43) Pub. Date: Apr. 21, 2005

(54) Display device

(75) Inventors: Kazuo Yahagi, Yamanashi-ken (JP); Yuya Shiozaki, Yamanashi-ken (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/959,220

(22) Filed: Oct. 7, 2004

(30) Foreign Application Priority Data
Oct. 16, 2003 (JP) 2003-356698

(51) Int. Cl. G09G 3/28

(52) U.S. Cl. 345/60

(57) ABSTRACT

In each of a plurality of sub-fields forming a field, in order to cause continuous luminescence of the pixel, at least one of the sustain pulses to be applied in the later section in a sustain period for which sustain pulses are to be repeatedly applied has a pulse voltage amplitude given greater than a pulse voltage amplitude of the other sustain pulse.

### BACKGROUND OF THE INVENTION

1. Field of the Invention

The present invention relates to a display device having a display panel.

2. Description of the Related Art

In the recent, there are commercially produced plasma displays having plasma display panels (hereinafter, also referred to as PDPs) as color display panels large in size but small in thickness.

The PDP is provided with a front glass substrate serving as a display surface and a back substrate oppositely arranged, through a discharge space filled with a discharge gas. The front glass substrate is formed with a plurality of strip-formed row electrodes extending in a row direction of the display surface, on an inner surface thereof (i.e., the surface opposed to the back substrate). Meanwhile, the back substrate is formed with a plurality of strip-formed column electrodes extending in a column direction of the display surface. In this case, the adjacent row electrodes in a pair (hereinafter, referred to as row electrode pair) serve as one display line. Discharge cells, serving as pixels, are structurally formed at intersections of the row electrode pairs and the column electrodes.

Furthermore, the PDP is provided with a row electrode driver for applying various pulses (described later) to the row electrodes and an address driver for applying to the column electrodes a pixel data pulse corresponding to an input video signal.

The row electrode driver first applies a reset pulse simultaneously to all the row electrode pairs, to cause reset-discharge in all the discharge cells. By such reset discharge, on-wall charge is formed within all the discharge cells. Then, the address driver applies a plurality of pixel data pulses corresponding to the display lines in an amount of one display line per time to the column electrodes. In this duration, the row electrode driver applies a scan pulse sequentially to one row electrodes of the row electrode pairs, in order to put the discharge cells belonging to the display line into subject of discharge in an amount of one display line per time. On this occasion, address discharge is selectively caused within the discharge cell to which the high-voltage pixel data pulse and the scan pulse are applied at the same time, thereby erasing the on-wall charge remaining within the discharge cell. Next, the row electrode driver applies a sustain pulse alternately and repeatedly to the row electrodes of all the row electrode pairs. On this occasion, sustain discharge takes place only in the discharge cells having the remaining on-wall charge each time the sustain pulse is applied. The sustain discharge provides luminescence to cause an image to appear on a display surface of the front glass substrate correspondingly to the input video signal.

However, the above driving causes luminescent discharge, such as reset discharge and address discharge not to be involved in displaying an image, thus raising a problem of lowered contrast in a display image.

For this reason, a proposal has been made on a PDP achieving to improve the contrast of display image by suppressing the luminescence as caused by reset and address discharge as is disclosed, for example, in Japanese Patent Application Kokai No.2003-86108 (hereinafter, referred to as Patent Document 1).

FIG. 1 is a figure of part of such a PDP as viewed from a display surface side (see FIG. 1 in Patent Document 1). FIG. 2 is a figure showing a section along V1-V1 in the display panel shown in FIG. 1 (see FIG. 2 in Patent Document 1).

In the PDP shown in FIG. 1, each discharge cell is constructed by a display cell C1 for causing sustain discharge only, and a reset-and-address discharge cell C2 for causing reset and address discharge with luminescence not to be involved in displaying an image. The display cell C1 and the reset-and-address discharge cell C2 have respective discharge spaces that are in communication through a gap r as shown in FIG. 2. The address discharge caused within the reset-and-address discharge cell C2 is extended toward the display cell C1 through the gap r. This places the display cell C1 in any one of an on-wall charge formed state allowing for sustain discharge under application of a sustain pulse (on mode) and an on-wall charge formed state not allowing for sustain discharge (off mode). Accordingly, sustain discharge is caused only within the display cell C1 set in on mode under application of a sustain pulse. The light caused by discharge is radiated to the outside through the front glass substrate 10, as shown in FIG. 2. On the other hand, in the reset-and-address discharge cell C2, a light-absorbing layer 18 in black or dark color shown in FIG. 2 is formed in order to block off the light caused by reset and address discharge from radiating to the outside.

Therefore, by the light-absorbing layer 18, the light caused by reset and address discharge can be reduced in leak amount toward the display surface, hence improving the contrast of display image. Here, in order to cause address discharge within the reset-and-address discharge cell C2, it is a practice to utilize a sustain discharge caused within the display cell C1 immediately before that time. Namely, by the sustain discharge caused within the display cell C1, a charged particle is produced to leak toward the reset-and-address discharge cell C2 through the gap r as shown in FIG. 2. This enables to stably cause an address discharge within the reset-and-address discharge cell C2.

However, there is a problem that there encounters a reduction in the efficiency of luminescence based on a sustain discharge within the display cell, by an amount of flowing out of the charged particle from the display cell toward the reset-and-address discharge cell C2.

### SUMMARY OF THE INVENTION

The present invention has been made in order to solve the problem, and it is an object thereof to provide a display device capable of stabilizing discharge and improving luminescent efficiency.

According to the present invention, there is provided a display apparatus for displaying an image by causing luminescence on pixels in each of a plurality of sub-fields forming a field according to pixel-based pixel data on a basis of an input video signal, the display apparatus comprises a display panel having front and back substrate oppositely arranged sandwiching a discharge space, a plurality of row electrode pairs covered with a dielectric layer and arranged on an inner surface of the front substrate, and a plurality of address electrodes arranged crossing the electrode pairs, wherein the electrode pairs and the address electrodes have intersections each formed with a unit luminescent region having a first discharge cell and a second discharge cell having a light absorbing layer provided on the front substrate side; an addressing unit for applying, while applying a scanning pulse sequentially to one electrodes of the row electrode pairs, a pixel data pulse corresponding to the pixel data to column electrodes simultaneously with the scanning pulse, in an address period of each of the sub-fields thereby causing address discharge within the second discharge cell; and a sustain unit for applying a sustain pulse to the row electrode pairs in a sustain period of each of the sub-fields thereby causing a sustain discharge in the first discharge cell; wherein at least one sustain pulse of successive sustain pulses in the number of N (N: integer equal to or greater than 2) including the sustain pulse to be applied the last in the sustain period has a pulse voltage amplitude greater than a pulse voltage amplitude of the other sustain pulse.

### BRIEF DESCRIPTION OF THE DRAWINGS

FIG. 1 is a plan view of part of a conventional PDP structure as viewed from a display surface side;

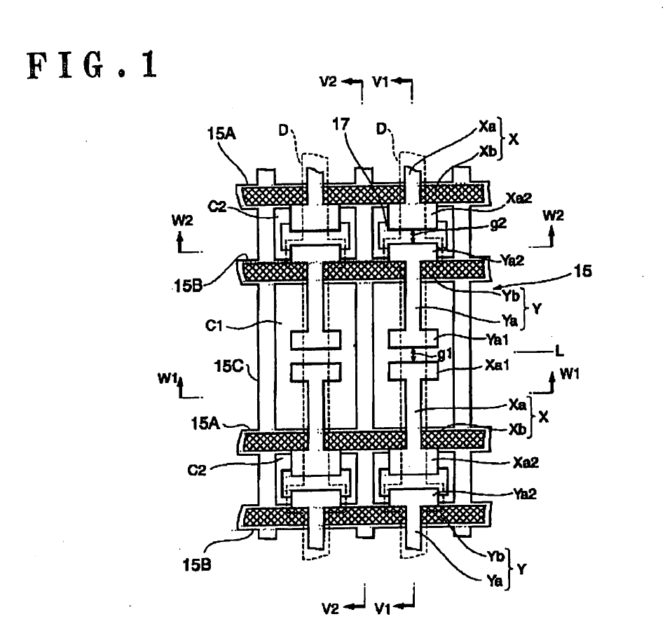

FIG. 2 is a view showing a section of the PDP on line V-V shown in FIG. 1;

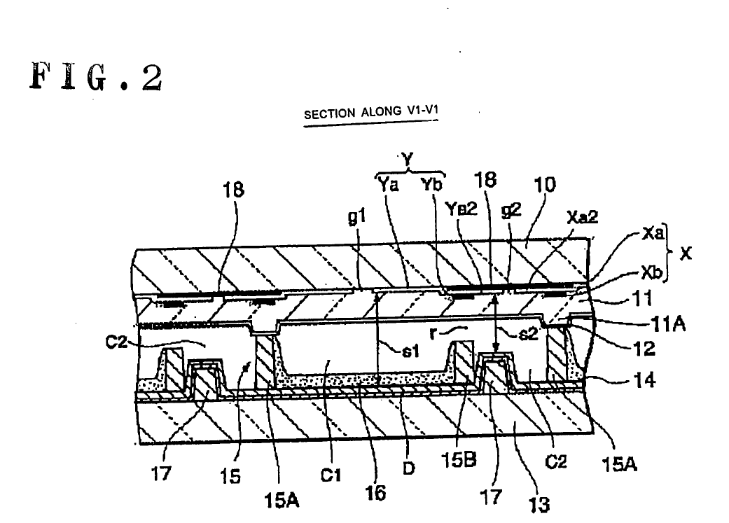

FIG. 3 is a diagram schematically showing an arrangement of a plasma display device according to the present invention;

FIG. 4 is a plan view of part of a structure of PDP 50 shown in FIG. 3, as viewed from a display surface side;

FIG. 5 is a view showing a section on line V1-V1 shown in FIG. 4;

FIG. 6 is a view showing a section on line V2-V2 shown in FIG. 4;

FIG. 7 is a view showing a section on line W1-W1 shown in FIG. 4;

FIG. 8 is a figure showing a pixel data conversion table and a luminescence drive pattern based on the pixel drive data GD obtained by the pixel data conversion table;

FIG. 9 is a figure showing an example of a luminescence drive sequence in the plasma display device shown in FIG. 3;

FIG. 10 is a figure showing various drive pulses to be applied to the PDP 50 according to the luminescence drive sequence shown in FIG. 9;

FIG. 11 is a figure showing another example of various drive pulses to be applied to the PDP 50 according to the luminescence drive sequence shown in FIG. 9;

FIG. 12 is a figure showing another example of various drive pulses to be applied to the PDP 50 according to the luminescence drive sequence shown in FIG. 9.

### DETAILED DESCRIPTION OF THE INVENTION

In each of a plurality of sub-fields forming a field, in order to cause continuous luminescence of the pixel, at least one of the sustain pulses to be applied in the later section in a sustain period for which sustain pulses are to be repeatedly applied has a pulse voltage amplitude given greater than a pulse voltage amplitude of the other sustain pulse.

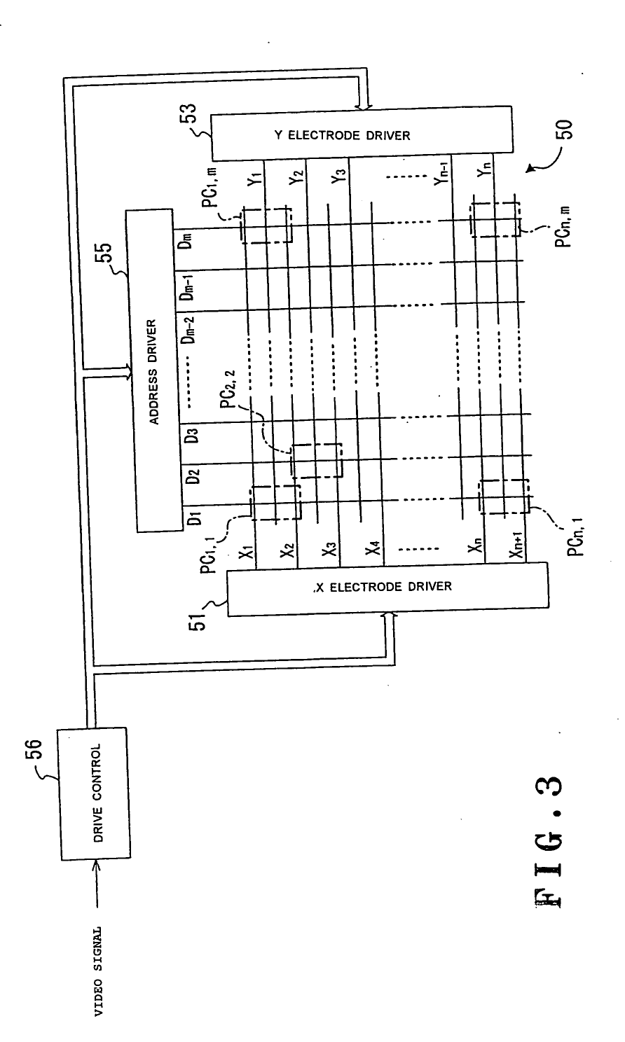

FIG. 3 is a diagram showing an arrangement of a plasma display device as a display device according to the present invention.

As shown in FIG. 3, the plasma display device includes a PDP 50 as a plasma display panel, an X-electrode driver 51, a Y-electrode driver 53, an address driver 55 and a drive control circuit 56.

In the PDP 50, there are formed strip-formed column electrodes (address electrodes) D₁-Dₘ each extending in a vertical direction of the display screen. Furthermore, on the PDP 50, there are formed strip-formed row electrodes X₁-Xₙ₊₁ and Y₁-Yₙ extending in a horizontal direction of the display screen alternately and in an numbered order, as shown in FIG. 3. In this case, the pairs of adjacent row electrodes (Y₁, X₂), (Y₂, X₃), (Y₃, X₄), . . . , (Yₙ, Xₙ₊₁) respectively serve for the first to n-th display lines of the PDP 50. Cells serving as pixels (hereinafter, referred to as pixel cells) PC are formed respectively at the intersections of the display lines and the column electrodes D₁-Dₘ (regions of the one-dot chain line in FIG. 3). Namely, on the PDP 50, there is an arrangement in a matrix form of pixel cells PC_{1,1}-PC_{1,m} belonging to the first display line, pixel cells PC_{2,1}-PC_{2,m} belonging to the second display line, . . . and pixel cells PC_{n,1}-P_{n,m} belonging to the n-th display line.

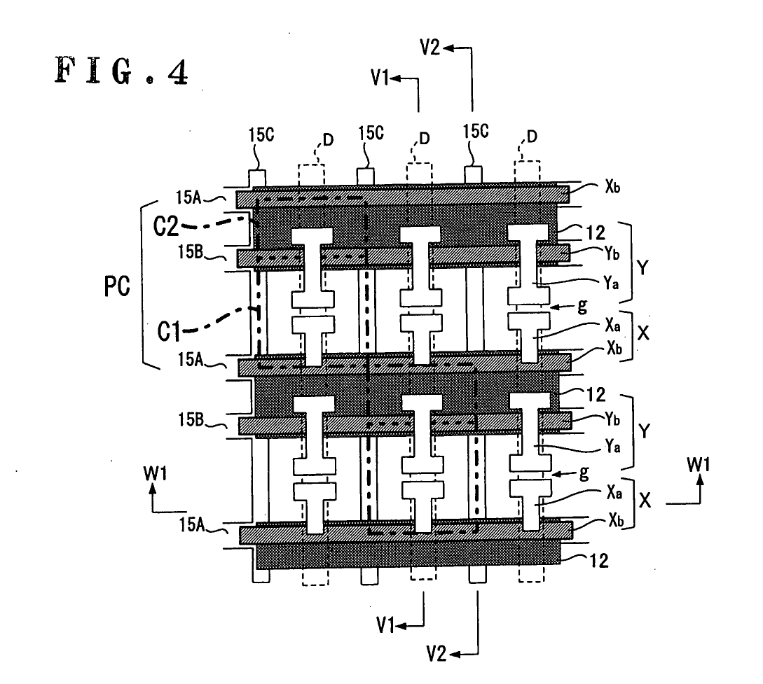

FIGS. 4 to 7 are views showing part, by excerption, of an internal structure of the PDP 50.

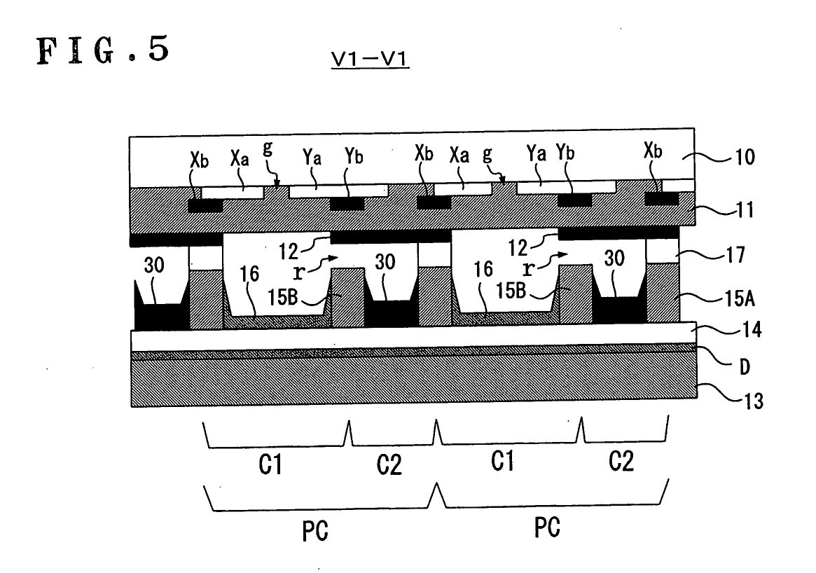

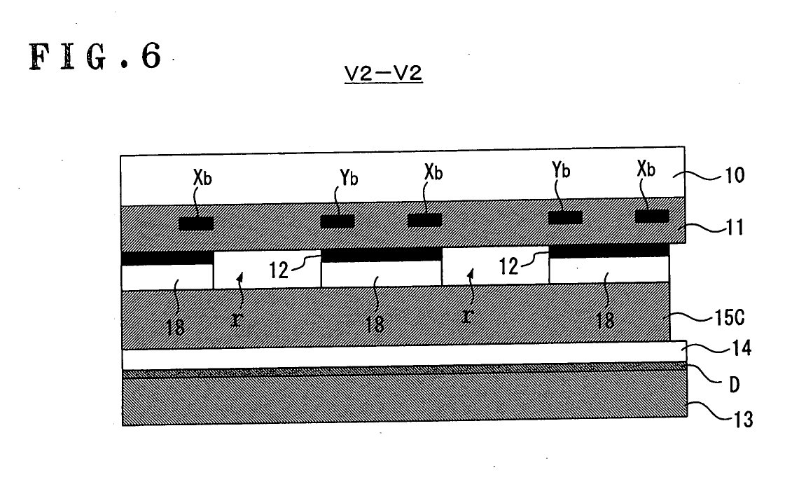

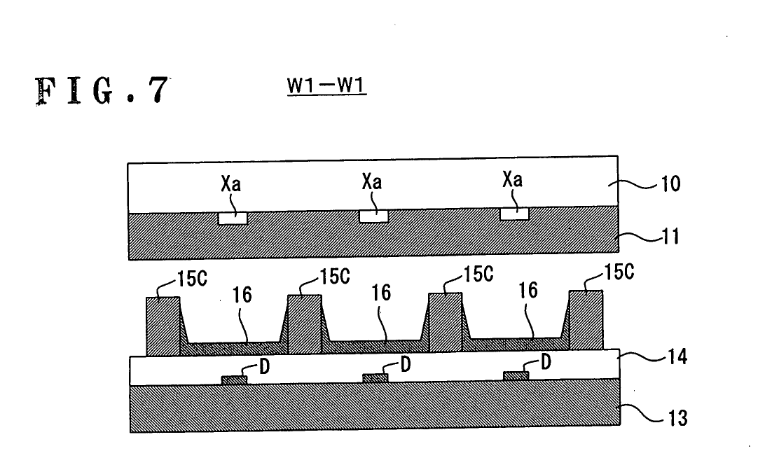

Specifically, FIG. 4 is a plan view as viewed from the display surface side. FIG. 5 is a sectional view as viewed from line V1-V1 shown in FIG. 4. FIG. 6 is a sectional view as viewed from line V2-V2 shown in FIG. 4. FIG. 7 is a sectional view as viewed from line W1-W12 shown in FIG. 4.

As shown in FIG. 4, the row electrode Y is constituted by a bus electrode Yb (main body portion of the row electrode Y) in a strip form extending in the horizontal (row) direction of the display screen and a plurality of transparent electrodes Ya connected to the bus electrode Yb. The bus electrode Yb is formed by a black metal film, for example. The transparent electrodes Ya are formed by a transparent conductive film such as of ITO, and arranged on the bus electrode Yb respectively in positions corresponding to the column electrodes D. The transparent electrode Ya extends in a direction orthogonal to the bus electrode Yb, whose one and the other ends are each made in a widened form as shown in FIG. 4. Namely, the transparent electrode Ya can be grasped as a projection electrode projecting from the main body portion of the row electrode Y. Meanwhile, the row electrode X is constituted by a bus electrode Xb (main body portion of the row electrode X) in a strip form extending in the horizontal (row) direction of the display screen and a plurality of transparent electrodes Xa connected to the bus electrode Xb. The bus electrode Xb is formed by a black metal film, for example. The transparent electrodes Xa are formed by a transparent conductive film such as of ITO, and arranged on the bus electrode Xb respectively in positions corresponding to the column electrodes D. The transparent electrode Xa extends in a direction orthogonal to the bus electrode Xb, whose one and the other end are made in a widened form as shown in FIG. 4. Namely, the transparent electrode Xa can be understood as a projection electrode projecting from the main body of the row electrode X. The widened portions of the transparent electrodes Xa and Yb are arranged oppositely to each other through a predetermined width of discharge gap g, as shown in FIG. 4. Namely, the transparent electrodes Xa and Ya, as projection electrodes projecting from the main bodies of the paired row electrodes X and Y, are oppositely arranged to each other through the discharge gap g.

The row electrodes Y, comprised of the transparent electrodes Ya and bus electrodes Yb and the row electrodes X, comprised of the transparent electrodes Xa and bus electrodes Xb, are formed on a backside of a front transparent substrate 10 serving as a display surface of the PDP 50, as shown in FIG. 5. Furthermore, a dielectric layer 11 is formed on a back surface of the front transparent substrate 10, to cover over those row electrodes X and Y. On the surface of the dielectric layer 11, a protruding dielectric layer 12 is formed protruding from the dielectric layer 11 toward the backside, in a position corresponding to each select cell C2 (referred later). The protruding dielectric layer 12 is formed by a strip-formed light-absorbing layer containing a black or dark-color pigment, to extend in a horizontal (row) direction of the display surface as shown in FIG. 4. The protruding dielectric layer 12 and the dielectric layer 11 free of the protruding dielectric layer 12 have their surfaces covered with a not-shown protection layer of MgO. On a back substrate 13 placed parallel with the front transparent substrate 10, a plurality of column electrodes D are arranged in parallel one with another through a predetermined gap and extending in a direction orthogonal to the bus electrodes Xb and Yb (in a column direction). On the back substrate 13, a column-electrode protection layer (dielectric layer) 14 in white is formed covering over the column electrodes D. On the column-electrode protection layer 14, a barrier wall 15 is formed comprising a first horizontal wall 15A, a second horizontal wall 15B and a vertical wall 15C. The first horizontal wall 15A is formed extending in the horizontal direction of the display surface, in a position on the column-electrode protection layer 14 opposed to the bus electrode Yb. The second horizontal wall 15B is formed extending in the horizontal (row) direction of the display surface, in a position on the column-electrode protection layer 14 opposed to the bus electrode Xb. The vertical wall 15C is formed extending in a direction orthogonal to the bus electrode Xb (Yb), in a position between the transparent electrodes Xa (Ya) arranged at an equal interval on the bus electrode Xb (Yb). As shown in FIG. 5, a secondary-electron emitting material layer 30 is formed on the column electrode protection layer 14 in a region opposed to the protruding dielectric layer 12 (including side surfaces of the vertical wall 15C and the first and second horizontal walls 15A and 15B). The secondary-electron emitting material layer 30 is a layer formed of a high-γ material low in work function (e.g. 4.2 eV or lower) but high in so-called secondary electron emission coefficient. The secondary electron emitting material layer 30 employs a material, for example, of an alkali earth metal oxide such as MgO, CaO, SrO and BaO; an alkali metal oxide such as Cs₂O; a fluoride such as CaF₂ and MgF₂; TiO₂, Y₂O; a material enhanced in secondary electron emission coefficient by crystal defect or impurity dope, or the like. Meanwhile, a fluorescent layer 16 is formed on the column electrode protection layer 14 in the other region than the region opposed to the protruding dielectric layer 12 (including side surfaces of the vertical wall 15C and the first and second horizontal walls 15A and 15B), as shown in FIG. 5. The fluorescent layer 16 includes three types of a red fluorescent layer for luminescence in red, a green fluorescent layer for luminescence in green and a blue fluorescent layer for luminescence in blue, which are fixedly assigned to the pixel cells PC. There exists a discharge space filled with a discharge gas defined between the secondary electron emitting material layer 30 and fluorescent layer 16 and the dielectric layer 11. The first and second horizontal walls 15A, 15B and the vertical wall 15C are not so high as reaching a surface of the protruding dielectric layer 12 or dielectric layer 11, as shown in FIGS. 5 and 7. Thus, a gap r exists between the second horizontal wall 15B and the protruding dielectric layer 12 as shown in FIG. 5, allowing for communication of the discharge gas. However, between the first horizontal wall 15A and the protruding dielectric layer 12, a dielectric layer 17 is formed extending in a direction along the first horizontal wall 15A in order to prevent against discharge gas interference. Meanwhile, between the vertical wall 15C and the protruding dielectric layer 12, a dielectric layer 18 is formed intermittently in a direction along the vertical wall 15C, as shown in FIG. 6.

Here, the region surrounded by the first horizontal wall 15A and the vertical wall 15C (the region shown by the one-dot chain line in FIG. 4) is given as a pixel cell PC serving as a pixel. As shown in FIGS. 4 and 5, the pixel cell PC is divided into a display discharge cell C1 and a selection discharge cell C2 by the second horizontal wall 15B. The display discharge cell C1 includes transparent electrodes Xa and Ya of a pair of row electrodes X and Y serving as a display line and a fluorescent layer 16, as shown in FIGS. 4 and 5. Meanwhile, the selection discharge cell C2 includes a protruding dielectric layer 12, a second electron emission material layer 30, a row electrode Y of a pair of row electrodes corresponding to a display line, and a bus electrode Xb of a row electrode X of an electrode pair corresponding to the adjacent display line above the relevant display line. Incidentally, as shown in FIG. 4, the discharge gap g, provided between the broadened portion of the transparent electrode Xa and the broadened portion of the transparent electrode Xb, lies at an intermediate position between the bus electrode Xb and the bus electrode Yb within the display discharge cell C1.

As shown in FIG. 5, the respective discharge spaces of the adjacent pixel cells PC that are adjacent to each other with respect to the vertical direction (left-right direction in FIG. 5) of the display surface are blocked by the first horizontal wall 15A and dielectric layer 17. Nevertheless, the respective discharge spaces of the display discharge cell C1 and the selection discharge cell C2 that belong to the same pixel cell PC are in communication through a gap r, as shown in FIG. 5. Furthermore, the respective discharge spaces of the mutually adjacent select cells C2 with respect to the left-right direction of the display surface are blocked by the protruding dielectric layer 12 and dielectric layer 18, as shown in FIG. 6. However, the respective discharge spaces of the mutually adjacent display cells C1 with respect to the left-right direction of the display surface are in communication with each other.

In this manner, the pixel cells PC_{1,1}-P_{n,m} formed in the PDP 50 are each structured with a display discharge cell C1 and a selection discharge cell C2 which have the respective discharge spaces communicating with each other.

The X electrode driver 51 applies various pulses (described later) to the row electrodes X₁-Xₙ₊₁ of the PDP 50, according to a timing signal supplied from the drive control circuit 56. The Y electrode driver 53 applies various pulses (referred later) to the row electrodes Y₁-Yₙ of the PDP 50, according to a timing signal supplied from the drive control circuit 56. The address driver 55 applies a pixel data pulse (described later) to the column electrodes D₁-Dₘ of PDP 50, according to a timing signal supplied from the drive control circuit 56.

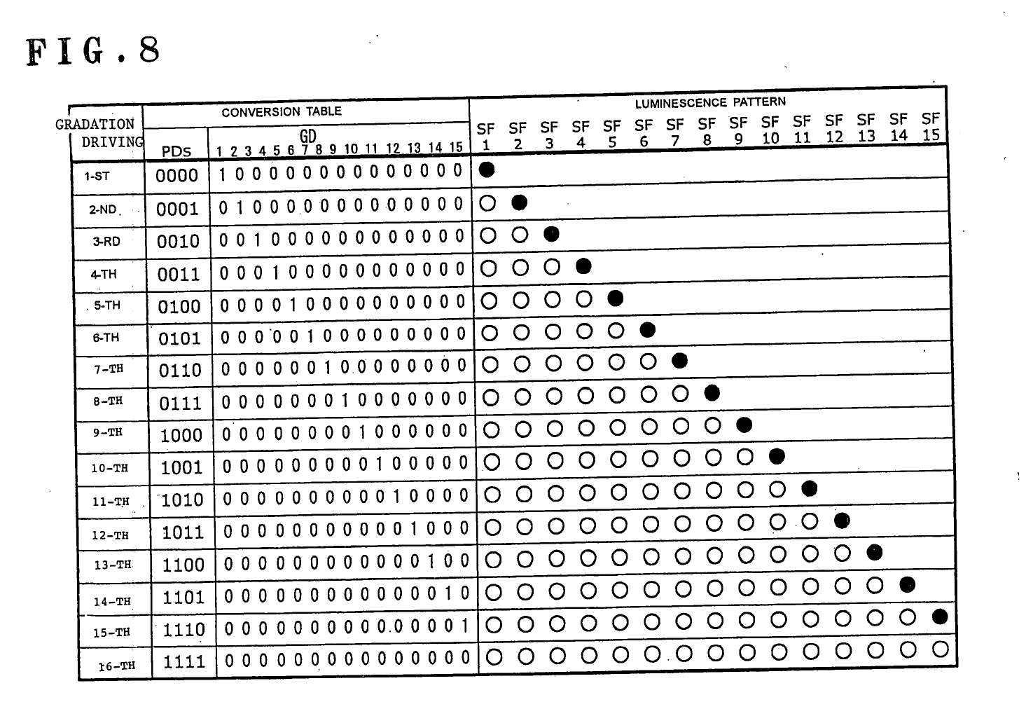

The drive control circuit 56 first converts the input video signal into, for example, 8-bit pixel data representing a luminance level on each pixel and carries out an error diffusion process and dither process on the pixel data. For example, in the error diffusion process, firstly the higher 6 bits of the pixel data is taken as display data and the remaining lower 2 bits as error data. The error data of the image data corresponding to each peripheral pixel is summed up by weighting into reflection in the display data. By this operation, the luminance in an amount of the lower 2 bits of the original pixel is expressed by the peripheral pixels in a pseudo-representation fashion. Therefore, by use of display data in an amount of 6 bits less than 8 bits, luminance tonal expression is made feasible equivalent to the pixel data in an amount of 8 bits. Dither process is carried out on 6-bit error-diffused pixel data obtained by the error diffusion process. In the dither process, a plurality of mutually adjacent pixels are taken as one pixel unit. The error diffused pixel data corresponding to each pixel of the one pixel unit are added by respectively assigning dither coefficients different in value, thereby obtaining dither addition pixel data. According to such dither coefficient addition, it is possible to express a luminance corresponding to 8 bits by use of the higher 4 bits only of the dither addition pixel data as seen on the 1-pixel unit basis. For this reason, the drive control circuit 56 extracts the higher 4 bits of dither addition pixel data as multi-toned or multi-gradation pixel data PDs. This is converted into 15-bit pixel drive data GD comprising the first to 15-th bit according to a data conversion table shown in FIG. 8. Accordingly, the pixel data capable of expressing 256 levels by 8 bits is converted into totally 16 patterns of 15-bit pixel drive data GD, as shown in FIG. 8. Next, the drive control circuit 56 separates the pixel drive data GD_{1,1}-GD_{n,m} at the same bit place, based on pixel drive data GD_{1,1}-GD_{n,m} corresponding respectively to the pixel cells PC_{1,1}-PC_{n,m} thereby obtaining pixel drive data bit group DB1-DB15 as follows.
DB1: 1-st bit of each of pixel drive data GD_{1,1}-GD_{n,m}
DB2: 2-nd bit of each of pixel drive data GD_{1,1}-GD_{n,m}
DB3: 3-rd bit of each of pixel drive data GD_{1,1}-GD_{n,m}
DB4: 4-th bit of each of pixel drive data GD_{1,1}-GD_{n,m}
DB5: 5-th bit of each of pixel drive data GD_{1,1}-GD_{n,m}
DB6: 6-th bit of each of pixel drive data GD_{1,1}-GD_{n,m}
DB7: 7-th bit of each of pixel drive data GD_{1,1}-GD_{n,m}
DB8: 8-th bit of each of pixel drive data GD_{1,1}-GD_{n,m}
DB9: 9-th bit of each of pixel drive data GD_{1,1}-GD_{n,m}
DB10: 10-th bit of each of pixel drive data GD_{1,1}-GD_{n,m}
DB11: 11-th bit of each of pixel drive data GD_{1,1}-GD_{n,m}
DB12: 12-th bit of each of pixel drive data GD_{1,1}-GD_{n,m}
DB13: 13-th bit of each of pixel drive data GD_{1,1}-GD_{n,m}
DB14: 14-th bit of each of pixel drive data GD_{1,1}-GD_{n,m}
DB15: 15-th bit of each of pixel drive data GD_{1,1}-GD_{n,m}

Note that the pixel drive data bit groups DB1-DB15 respectively correspond to sub-fields SF1-SF15, described later.

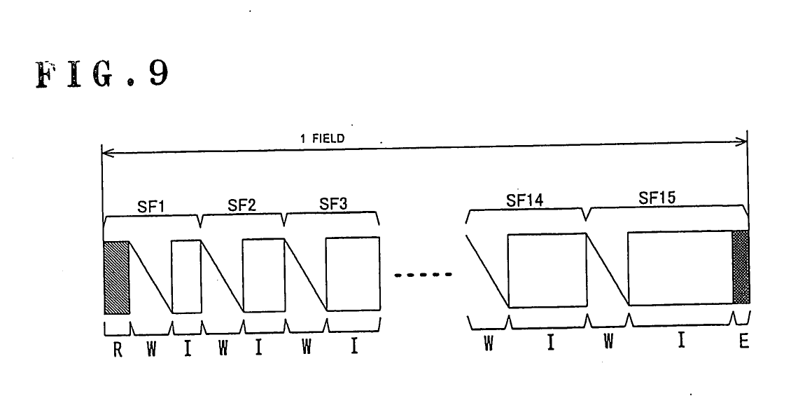

Here, the drive control circuit 56, in each of fifteen sub-fields SF1-SF15 constituting the fields of a video signal, carries out a drive control based on an address period W and a sustain period I (referred later) onto the X electrode driver 51, the Y electrode driver 53 and the address driver 55, as shown in FIG. 9. In this duration, the drive control circuit 56, in the address period W in each of sub-fields SF1-SF15, supplies a pixel drive data bit group DB corresponding to the relevant sub-field SF in an amount of one display line (m in the number) per time to the address driver 55. The drive control circuit 56, only in the starting sub-field SF1, carries out drive control based on a reset period R (referred later) in advance of the address period W and, only in the last sub-field SF15, carries out drive control based on an erase period E (referred later) immediately after the sustain period I.

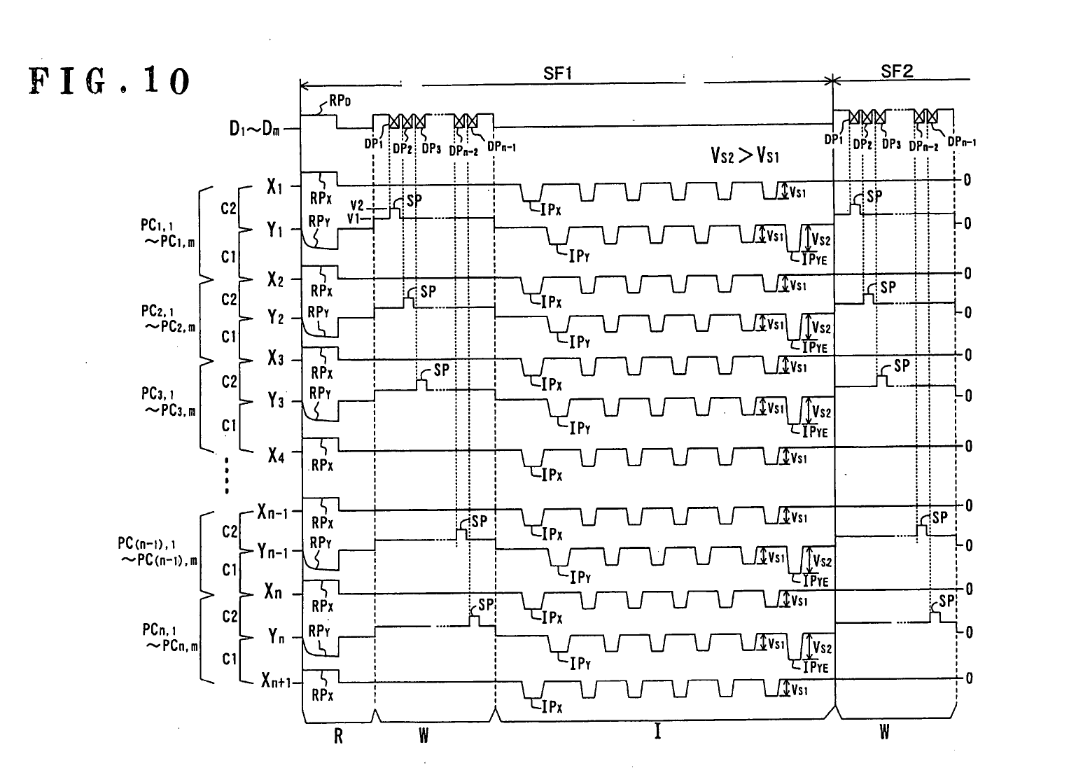

FIG. 10 is a figure showing various drive pulses which the X electrode driver 51, the Y electrode driver 53 and the address driver 55 are to apply to the PDP 50 in accordance with carrying out of the above drive control. Incidentally, FIG. 10 shows, by excerption, only the starting sub-field SF1 of the sub-fields SF1-SF15 shown in FIG. 9.

At first, in the reset period R, the X electrode driver 51 generates a reset pulse RP, in positive polarity and applies it simultaneously to the row electrodes X₁-Xₙ₊₁ of the PDP 50. During application of the reset pulse RPₓ, as shown in FIG. 10 the Y electrode driver 53 generates a reset pulse RP_{Y} moderate in fall change and in negative polarity and applies it simultaneously to the row electrodes Y₁-Yₙ of the PDP 50. In this duration, the address driver 55 generates a reset pulse RP_{D} in positive polarity and applies it simultaneously to the column electrodes D₁-Dₘ.

By applying the reset pulses RP_{D}, RP_{Y} and RP_{X}, reset discharge (write discharge) is caused at between the column electrode D and the row electrode Y within the selection discharge cell C2 of every pixel cell PC of the PDP 50. On-wall charge is formed within the selection discharge cell C2. Incidentally, by the application of the reset pulses RP_{D}, RP_{Y} and RP_{X}, the column electrodes D is placed as an anode relative to the row electrodes X and Y. Then, the reset discharge moves toward the display discharge cell C1 through the gap r shown in FIG. 5, to cause discharge at between the electrodes Y and X within the display discharge cell C1. By the movement of discharge, on-wall charge is formed within the display discharge cell C1 of every pixel cell PC.

In this manner, in the reset period R, on-wall charge is formed within the display discharge cell C1 of every pixel cell PC of the PDP 50, to initialize every pixel cell PC into an on-cell mode.

Next, in the address period W, the Y electrode driver 53 applies a scanning pulse SP having a positive-polarity voltage V2 (V2>V1) sequentially to the row electrodes Y₁-Yₙ, while applying a positive-polarity voltage V1 to all the row electrodes Y₁-Yₙ. In this duration, the X electrode driver 51 places the row electrodes X₁-Xₙ₊₁ at 0V. The address driver 55 converts each data bit of the pixel drive data bit group DB corresponding to the sub-field SF into a pixel data pulse DP having a pulse voltage corresponding to a logical level thereof. For example, the address driver 55, on one hand, converts a pixel drive data bit having a logical level 0 into a pixel data pulse DP positive in polarity and high in voltage and, on the other hand, converts a pixel drive data bit having a logical level 1 into a pixel data pulse DP low in voltage (0 volt). Such pixel data pulses DP are applied in an amount of one display line (m in the number) per time to the column electrodes D₁-Dₘ, in synchronism with the application timing of the scanning pulse SP. Namely, the address driver 55 first applies a pixel data pulse group DP₁ comprising pixel data pulses DP in the number of m corresponding to the first display line to the column electrodes D₁-Dₘ, and then applies a pixel data pulse group DP₂ comprising pixel data pulses DP in the number of m corresponding to the second display line to the column electrodes D₁-Dₘ. On this occasion, erase address discharge is caused at between the row electrode D and the row electrode Y within the selection discharge cell C2 of the pixel cell PC to which the scanning pulse SP having a positive-polarity voltage V2 and the pixel data pulse DP having a low voltage (0 volt) are applied at the same time. Due to the erase address discharge, the discharge moves toward the display discharge cell C1 through the gap r in FIG. 5. Thus, discharge is caused at between the row electrodes Y and X within the display discharge cell C1. By movement of the discharge from the selection discharge cell C2 into the display discharge cell C1 as mentioned above, the on-wall charge formed within the discharge display cell C1 vanishes away. On the other hand, there is no occurrence of such erase address discharge within the selection discharge cell C2 of the pixel cell PC to which a high-voltage pixel data pulse DP is applied while a scanning pulse SP is applied. Accordingly, because there is no occurrence of such discharge movement from the selection discharge cell C2 to the display discharge cell C1 as mentioned above, the on-wall charge within the display discharge cell C1 maintains its formation state as it is. Namely, where on-wall charge exists within the display discharge cell C1, it remains as it is. Where it does not exist, the non-formation state of on-wall charge is maintained.

In this manner, in the address period W, erase address discharge is selectively caused within the selection discharge cell C2 of the pixel cell PC according to the data bit of a pixel drive data bit group corresponding to the sub-field, thereby erasing the on-wall charge. This sets the pixel cell PC on which on-wall charge remains into an on-cell mode and the pixel cell PC with of on-wall charge removed into an off-cell mode.

Next, in the sustain period I, the X electrode driver 51 repeatedly applies a negative-polarity sustain pulse IP_{X} to the row electrodes X₁-Xₙ₊₁ while the Y electrode driver 53 repeatedly applies a negative-polarity sustain pulse IP_{Y} to the row electrodes Y₁-Yₙ. Incidentally, as shown in FIG. 10, the sustain pulse IP_{YE} to be applied the last within the sustain period I has a pulse-voltage amplitude V_{S2} approximately 10-50 volts greater than a pulse-voltage amplitude V_{S1} of the sustain pulse IP_{Y} and IP_{X} to be applied up to immediately before that time. Meanwhile, in the sustain period I of each sub-field, sustain pulses IP_{X} and IP_{Y} are applied the number of times assigned to the sub-field to which the relevant sustain period I belongs. When a sustain pulse IP_{X} or IP_{Y} (including IP_{YE}) is applied, sustain discharge is caused at between the transparent electrodes Xa and Ya within the display discharge cell C1 of the pixel cell PC set in the on-cell mode. Due to a ultraviolet ray caused by such sustain discharge, as shown in FIG. 5 there is caused excitation in the fluorescent layer 16 (red fluorescent layer, green fluorescent layer and blue fluorescent layer) formed within the display discharge cell C1, to cause a radiation corresponding to the fluorescent color through the front transparent substrate 10. Namely, luminescence is repeatedly caused based on sustain discharge the number of times assigned to the sub-field to which the sustain period I belongs. Visual perception is obtained at a luminescence commensurate with the number of times. Namely, with driving based on 16 patterns of pixel drive data GD as shown in FIG. 8, erase address discharge is caused only within the address period W of one of sub-fields SF1-SF15 (shown by solid circle), to set the pixel cell PC into an off-cell mode. Namely, in each pixel cell PC, luminescence is repeatedly caused based on sustain discharge by the number of times assigned to the sub-field in a duration of from a setting to an on-cell mode in the reset period R of the starting sub-field SF1 to a setting to an off-cell mode in the address period W of any one of sub-fields SF1-SF15 (shown by open circle). On this occasion, visual perception is obtained at a luminance corresponding to the total number of luminescence based on sustain discharge caused within one sub-field. Consequently, according to the 16 luminescent patterns based on first to sixteenth tonal levels driving as shown in FIG. 8, expression is obtained at a halfway intensity in 16 levels corresponding to the total number of times of sustain discharge caused in the sub-fields shown by the open circles.

Here, the sustain pulse IP_{Y} and IP_{X} has a pulse-voltage amplitude V_{S1} set at a comparatively small amplitude for the charged particle not to extend toward the selection discharge cell C2 due to the sustain discharge caused by application of the sustain pulse. Accordingly, because there is eliminated of flowing out of the charged particle formed within the discharge space of the display discharge cell C1 due to sustain discharge, luminescent efficiency can be improved. By making comparatively small the pulse voltage amplitude of the sustain pulse IP_{Y} and IP_{X}, the dielectric layer 11 can be suppressed from deteriorating due to sustain discharge, thus enabling to increase the life of the PDP 50. Furthermore, the amplitude VS₂ of the sustain pulse IP_{YE} to be applied the last in the sustain period I is increased to such an extent that the charged particle formed by sustain discharge can be extended toward the selection discharge cell C2 through the gap r as shown in FIG. 5. Accordingly, because the charged particle remains in the discharge space of the selection discharge cell C2 immediately before the address period W of the next sub-field SF, address discharge can be stably caused in the address period W.

Incidentally, in the embodiment shown in FIG. 10, in order to extend the charged particle formed in the display discharge cell C1 toward the selection discharge cell C2, the sustain pulse IP_{YE} to be applied the last in the sustain period I is given a pulse voltage amplitude VS₂ greater than the amplitude V_{S1} of the sustain pulse IP_{Y} to be applied up to immediately before that time. However, this is not limitative.

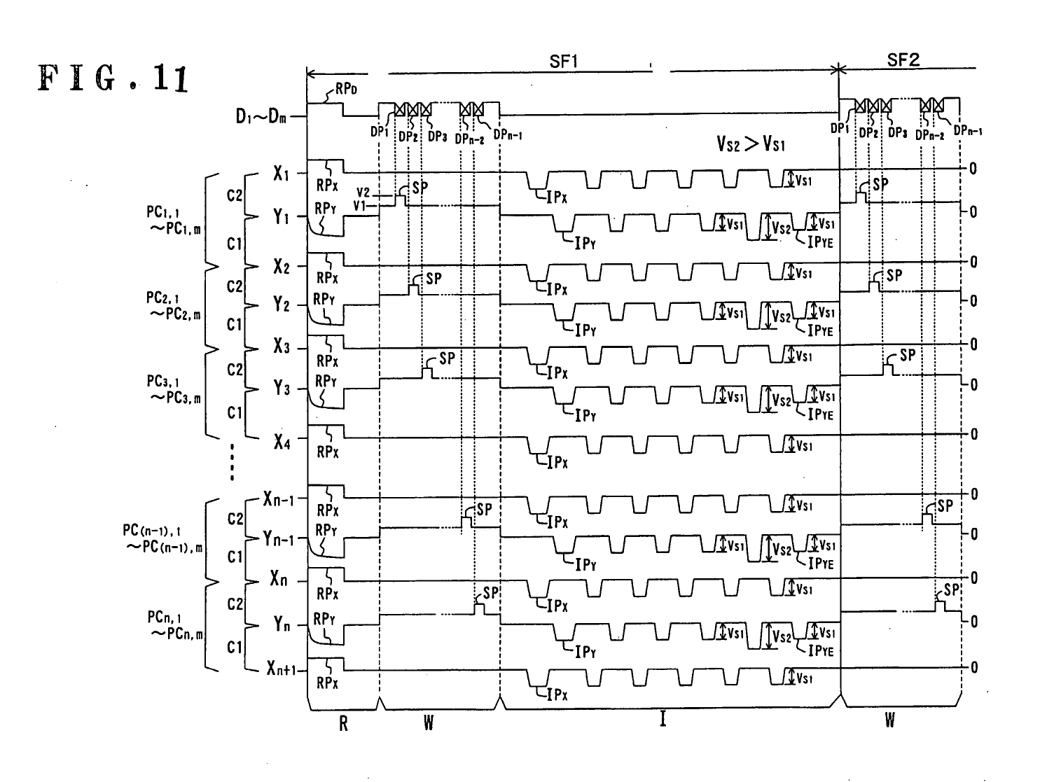

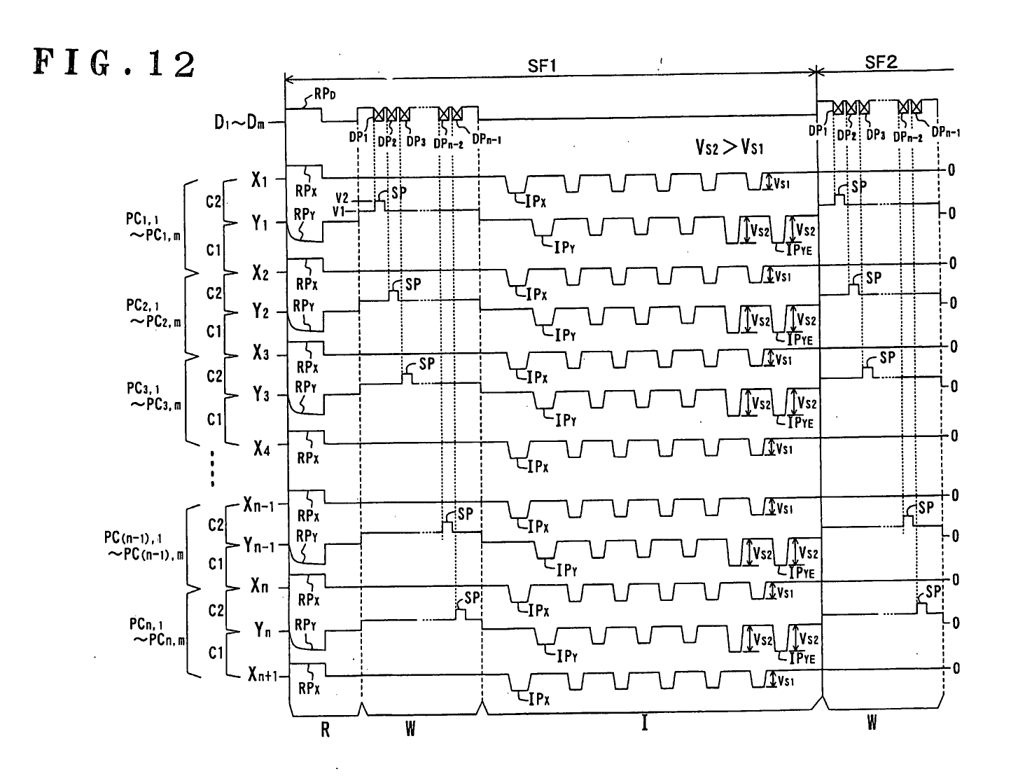

For example, as shown in FIG. 11, the sustain pulse IP_{YE} to be applied the last in the sustain period I may be given a pulse voltage amplitude V_{S1} while the sustain pulse IP_{Y} to be applied immediately before the sustain pulse IP_{YE} may be given a pulse voltage amplitude V_{S2} greater than the amplitude V_{S1}. Meanwhile, as shown in FIG. 12, only the sustain pulse IP_{YE} to be applied the last in the sustain period I and the sustain pulse IP_{Y} to be applied immediately before that time may be given a pulse voltage amplitude of V_{S2}.

In brief, it is satisfactory to provide at least one pulse of among the successive sustain pulses IP_{Y} in the number of N (N: integer equal to or greater than 2) including the sustain pulse IP_{YE} to be applied the last in the sustain period I, with a voltage amplitude greater than the pulse voltage amplitude of another sustain pulse.

Meanwhile, although the embodiment shown in FIGS. 10-11 adopts the driving that the column electrode D is relatively taken as a negative polarity to thereby cause reset and address discharge so that a negative-polarity sustain pulse can be applied to cause sustain discharge, the polarity may be inverted during driving. Namely, the column electrode D may be relatively taken as a positive polarity side to thereby cause reset and address discharge so that a positive-polarity sustain pulse IP can be applied to cause sustain discharge.

In the above embodiment, such an arrangement as X-Y, X-Y, X-Y, X-Y is adopted as an arrangement of row electrode pairs corresponding respectively to the first to n-th display lines of PDP50. However, the arrangement may be like X-Y, Y-X, X-Y, Y-X. In this case, placed adjacent mutually are a selection discharge cell C2 within the pixel cell PC belonging to the odd line and a selection discharge cell C2 within the pixel cell PC belonging to the even line.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No.2003-356698 which is hereby incorporated by reference.

1. A display apparatus for displaying an image by causing luminescence on pixels in each of a plurality of sub-fields forming a field according to pixel-based pixel data on a basis of an input video signal, the display apparatus comprising:
a display panel having front and back substrate oppositely arranged sandwiching a discharge space, a plurality of row electrode pairs covered with a dielectric layer and arranged on an inner surface of the front substrate, and a plurality of address electrodes arranged crossing the electrode pairs, wherein the electrode pairs and the address electrodes have intersections each formed with a unit luminescent region having a first discharge cell and a second discharge cell having a light absorbing layer provided on the front substrate side;
an addressing unit for applying, while applying a scanning pulse sequentially to one electrodes of the row electrode pairs, a pixel data pulse corresponding to the pixel data to column electrodes simultaneously with the scanning pulse, in an address period of each of the sub-fields thereby causing address discharge within the second discharge cell; and
a sustain unit for applying a sustain pulse to the row electrode pairs in a sustain period of each of the sub-fields thereby causing a sustain discharge in the first discharge cell;
wherein at least one sustain pulse of successive sustain pulses in the number of N (N: integer equal to or greater than 2) including the sustain pulse to be applied the last in the sustain period has a pulse voltage amplitude greater than a pulse voltage amplitude of the other sustain pulse.

2. A display apparatus according to claim 1, further comprising a secondary electron emitting material layer provided on the back substrate of the second discharge cell.

3. A display apparatus according to claim 1, further comprising a reset unit for applying a reset pulse having a pulse voltage to put the column electrodes relatively in negative polarity immediately preceding the address period to one row electrodes of the row electrode pairs and the column electrodes thereby causing a reset discharge within the second discharge cell,
the addressing unit generating the scanning pulse having a pulse voltage to put the column electrodes relatively in negative polarity and the pixel data pulse, the sustain unit generating the sustain pulse in negative polarity.

4. A display apparatus according to claim 1, wherein the first discharge cell and the second discharge cell have respective discharge sections in communication with each other within the unit luminescent region,
the addressing unit extending the address discharge caused in the second discharge cell into the first discharge cell thereby setting the first discharge cell into one state of an on mode allowing for sustain discharge in the sustain period and an off mode not allowing for sustain discharge in the sustain period.

5. A display apparatus according to claim 1, wherein the first discharge cell includes a portion where one row electrode and the other electrode of the row electrode pair are opposed to each other through a first discharge gap within the discharge space,
the second discharge cell including a portion where the one row electrode and the column electrode are opposed to each other through a second discharge gap within the discharge space.

6. A display apparatus according to claim 1, wherein one row electrode and the other electrode of the row electrode pair each have a main body portion extending in a row direction and projection portions opposed through the first discharge gap and projecting in a column direction from the main body portion in each of the unit luminescent regions,
the first discharge cell including a portion where the projections are opposed to each other through the first discharge gap within the discharge space, the second discharge cell including a portion where the main body portion of the one row electrode and the column electrode are opposed to each other through a second discharge gap within the discharge space.

7. A display apparatus according to claim 1, wherein the display panel has a barrier wall having a vertical wall defining in a row direction the discharge space of the unit luminescent regions adjacent to each other and horizontal wall defining the same in a column direction, and a partition wall defining between the discharge section of the first discharge cell and the discharge section of the second discharge cell within the unit luminescent region,
the discharge section of the second discharge cell of each of the unit luminescent regions is closed by the barrier wall from the discharge section of an adjacent one of the unit luminescent regions, the unit luminescent regions adjacent in the row direction having the first discharge cells having discharge sections in communication with each other and wherein the first discharge cell within the unit luminescent region has discharge sections in communication with each other.

8. A display apparatus according to claim 1, wherein a fluorescent layer for luminescence under discharge is formed only within the first discharge cell.

9. A display apparatus according to claim 1, wherein the first discharge cell and the second discharge cell have respective discharge sections in communication with each other within the unit luminescent region,
at least one sustain pulse of successive sustain pulses in the number of N including the sustain pulse to be applied the last in the sustain period has a pulse voltage amplitude in a degree that the sustain discharge caused by applying the sustain pulse extends from the first discharge cell into the second discharge cell whereas
the other sustain pulse has a pulse voltage amplitude in a degree that the sustain discharge caused by applying the sustain pulse stays within the first discharge cell.
